(19) United States
(12) Patent Application Publication
(10) Pub. No.: US 2005/0214440 A1
(43) Pub. Date: Sep. 29, 2005

(54) Method and apparatus for providing products of consistent properties for extrusion

(76) Inventors: Rick A. Aberle, Sabetha, KS (US); Gordon R. Huber, Sabetha, KS (US); Galen J. Rokey, Sabetha, KS (US)

Correspondence Address: Hovey Williams LLP, Suite 400, 2405 Grand Boulevard, Kansas City, MO, 64108, US

(21) Appl. No.: 10/812,230

(22) Filed: Mar. 29, 2004

(51) Int. Cl. A23J 3/00

(52) U.S. Cl. 426/656; 426/657; 426/805; 426/465; 366/348

(57) ABSTRACT

Methods of controlling waste streams and products in extrusion systems are provided in order to create from such materials consistent-quality recyclable waste streams which can be directly fed to an extruder without creating upset conditions or production of out of specification extrudates. In the methods of the invention, an incoming stream (10) of waste material including fat, protein, starch and moisture is blended to increase the homogeneity thereof whereupon the material is analyzed using one or more analyzers (16), especially microwave and near infrared analyzers. Such analysis creates a product signature for the material which is stored in a control microprocessor (28). The analyzed stream (10) can be modified as necessary by recirculation and/or addition of extra ingredients to create a final output stream (18) suitable for extrusion along with a primary stream (48) of extrudable material.

### BACKGROUND OF THE INVENTION

1. Field of the Invention

The present invention is broadly concerned with methods for managing waste streams and protein-containing streams and products incident to normal extrusion processing operations, in order to generate product streams of consistent properties which can be fed to the extrusion system. More particularly, the invention is concerned with such methods wherein waste such as out of specification extrudates, start up wastes and dryer/cooler fines, or protein-containing streams (e.g., slaughter house waste streams or fresh, uncooked animal protein streams) can be processed to obtain a final product which can be directly fed to the extrusion system without creating processing problems or upsets.

2. Description of the Prior Art

Process waste recycling is a problem faced by every extrusion manufacturing operation. Amounts of waste material are inevitably generated as a byproduct of such extrusion processing. These wastes can include out of specification product, start up materials (i.e., the materials generated at the start of a shift until the extrusion system is stabilized), fines from various sources, process water and other wastes. These wastes either must be disposed of as landfill or in some cases low-grade animal feeds, or be returned to the processing system in the form of rework material.

Problems arise in the consistency of composition of these wastes, as well as in the physical properties (e.g., viscosity, pH, average particle size) thereof. These issues make it difficult to directly use the wastes because, even though mixed with a primary incoming stream of material to the extruder, the inconsistencies of the rework material can cause system upsets themselves leading to the production of additional out of specification product. To give a specific example, variations in viscosity of rework waste may make it necessary to add significant water thereto to facilitate conveyance of the waste to the extruder. However, such water addition can significantly alter the water content of the overall material fed to the extruder, thus requiring the operator to constantly adjust dry and wet product flow rates to the extruder. This problem is exacerbated because accurate real-time information about the consistency and make up of the waste materials is not available. Thus, use of waste in the traditional fashion can often create more problems than it solves.

Many pet food products and diets manufactured in today's pet food industry include fresh animal proteins as a part of their formulation. Many advantages are gained by including such fresh animal proteins, including the opportunity to realize premium prices at retail, increased customer appeal, superior palatability to the pet, and improved ranges of nutritional sources for a given diet.

Manufacturing a feed with animal protein therein raises a number of problems for the extrusion processor. These can include problems in warehousing of raw ingredients, ingredient spoilage, lack of consistency in the protein products (especially protein, fat and moisture levels), the need for extensive pre-extrusion preparation of the ingredients to obtain consistent particle sizes and viscosities, and the need to have special metering and conveying devices for the proteinaceous ingredients.

Dealing with these issues results in high expense levels for the producer, both in terms of capital equipment and day-to-day operating expense. For example, significant space and equipment must be dedicated to avoid ingredient waste. Moreover, variation in the consistency of protein, fat and moisture in the ingredients between batches means that the producer must constantly monitor these parameters and adjust the extrusion process accordingly. Thus, if moisture levels vary significantly, the extrusion operation must be modified to lessen the amount of added water at the extruder, else the final extruded product will be difficult to produce or will be out of specification.

Currently, fresh animal protein ingredients are purchased by the pet food manufacturer in a form either frozen in blocks or in a partially frozen slurry. This requires a significant investment in freezer warehouse space to store the products before processing. It also necessitates grinding, conveying, emulsifying and tempering equipment which is often necessary to produce a suitable input stream to the extrusion system.

### SUMMARY OF THE INVENTION

The present invention overcomes the problems outlined above and provides an improved method of managing waste and/or animal protein-containing streams for extrusion processing, and yields consistent-quality waste streams which can be reliably reprocessed in the extrusion system. Broadly speaking, the method of the invention involves first providing an incoming waste stream including respective quantities of fat, protein, and moisture. This stream is blended in a blender with optional addition additives (e.g., fat, protein, starch-containing materials such as grains, pH modifiers). Thereafter, the blended material is analyzed using one or more analyzers to determine at least the moisture content thereof, and preferably at least one further characteristic selected from the group consisting of protein content, fat content, starch content, pH, viscosity, solids content and presence of contaminants. An output stream is created downstream of the analyzer, this being adjusted in terms of its characteristics in response to the results of the blended stream analysis; such adjustment may typically involve addition of further quantities of the waste stream material or any of the foregoing addition additives. This characteristic-adjusted output stream is then fed to the extruder for processing with a primary virgin stream of extrudable material.

The methods of the invention may be carried out in batch or in continuous systems. In the case of batch processing, the adjusting step may involve recirculation of at least a portion of the analyzed stream back to the blender for mixing with incoming waste material and/or optional ingredients. In all cases, it is preferred that the analysis be carried out using one or more devices which generate a beam of energy which is transmitted through a cross section of the material. Particularly good results have been found with microwave, infrared (especially near infrared (NIR)), X-ray and ultrasound analyzers, and it is preferred to use a combination of analyzers to give the best results.

Although not ordinarily essential, the process of the invention may also include an emulsification step subsequent to blending and prior to item analysis. Such emulsification may be needed where the incoming waste material is of uncertain or variable particle size, the emulsification being carried out so that the waste stream comprises particles having a maximum dimension of up to about 7mm, and more preferably about up to 1mm.

### BRIEF DESCRIPTION OF THE DRAWINGS

FIG. 1 is a schematic flow chart depicting a preferred batch process in accordance with the invention; and

FIG. 2 is a schematic flow chart depicting a preferred continuous process in accordance with the invention.

### DETAILED DESCRIPTION OF THE PREFERRED EMBODIMENT

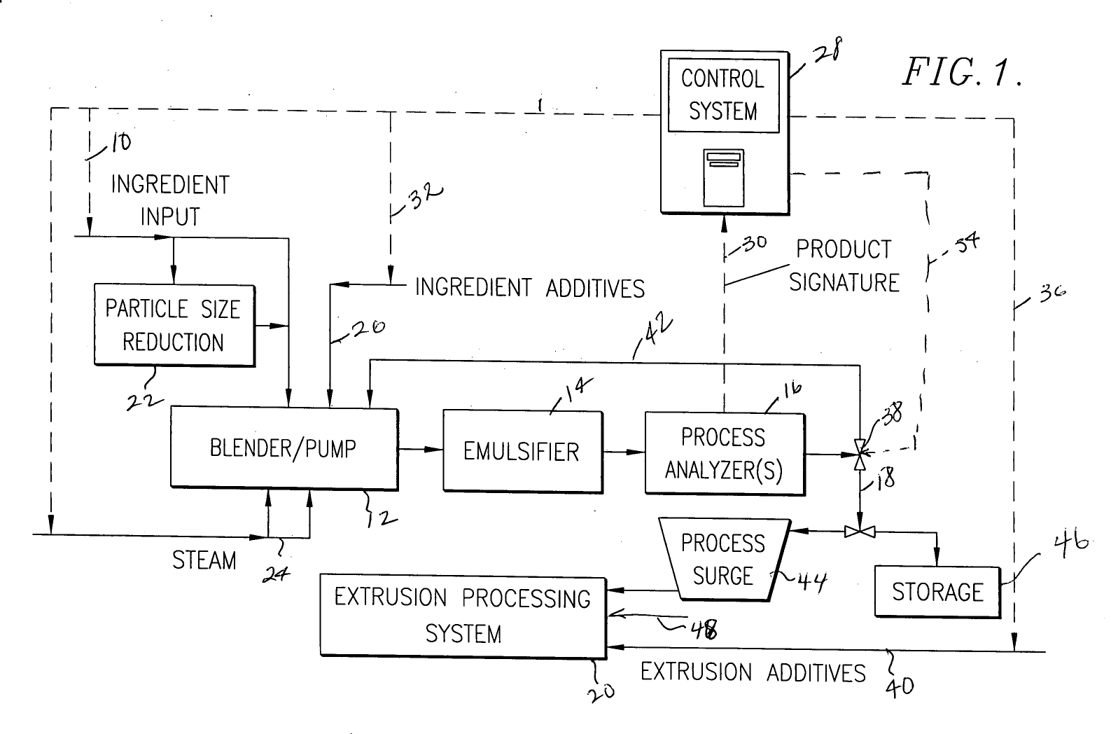

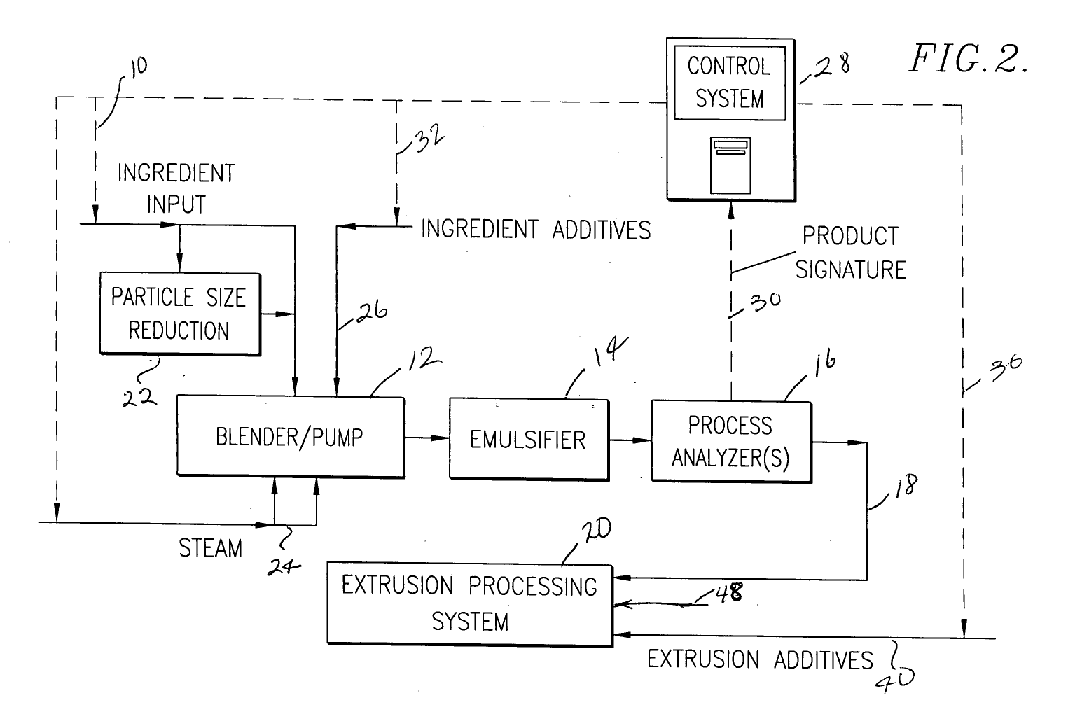

Preferred processes of batch or continuous nature are schematically depicted in FIGS. 1 and 2. Turning first to the batch process of FIG. 1, it will be observed that the overall system is designed to process an incoming waste stream 10 normally containing at least protein, fat, and moisture to produce a desired output which can be directly fed to an extruder for processing therein. Typical extruder waste streams would also include starch-containing grains or other materials. Preferably this batch process includes blending in a blending pump or device 12, emulsification using an emulsifier 14, and analysis employing one or more process analyzers 16. Ultimately, a final product stream 18 is created which can be directed to an extrusion processing system 20, having a conventional single or twin screw extruder as a part thereof. Although not shown, it is possible to perform the operative steps of the process in a CO2 or otherwise reduced oxygen atmosphere; such is particularly desirable where high quantities of fresh, uncooked animal protein materials are being processed, and/or extended storage times are contemplated.

In more detail, the incoming stream 10 may be made up of rework or waste (e.g., out of specification) product derived from extrusion system 20, such as that produce during start up of the system or during upset conditions. A consistent problem with such waste products is wide variability in the makeup thereof, a particular problem addressed by the present invention. The incoming stream 10 may also contain substantial quantities of fresh, uncooked animal-derived protein such as that derived from slaughter house wastes.

The initial processing step may include particle size reduction in a grinder 22 or similar device, but this may not be required. In any case, the stream 10, whether or not initially size-reduced, is directed to device 12 where it is blended. In this station, steam and/or carbon dioxide may be added via inputs 24. Additionally, water, fat, tallow or other minor ingredients may also be added through input 26. Again, the function of blending is to move toward the final consistent product which can be efficiently processed in extrusion system 20.

A variety of blending devices can be used in this context. However, the blender/pump depicted and described in pending application for U.S. Letters Patent S/N 10/713,942 filed Nov. 14, 2003 (incorporated by reference herein) is especially preferred. This type of blender/pump is capable of thoroughly mixing the stream 10 as well as any additions thereto, and to direct this blended stream to emulsifier 14. Such a blender/pump includes twin shafts having a combination of paddles and ribbons that homogeneously mix and convey the material to associated pumping screws. The preferred device operates in such a matter to constantly keep the pumping screws overfull to ensure accurate pumping. The blender is equipped with temperature sensors for monitoring and control, as well as steam/CO2/water/other ingredient inputs. Finally, the blender/pump may be equipped with load cells or level probes to assist in loss-in-weight control and fill level control.

The emulsifier 14 is designed to create a substantially uniform output in terms of viscosity and product size. Emulsification should produce a product having solid particles with a maximum dimension of up to about 7mm, and more preferably up to about 1.5mm. A number of commercially available emulsifiers can be used, such as those produced by Cozzini, Inc. The emulsification process will often raise the temperature of the material, and because of this, careful temperature control in the upstream blender is advisable. While often preferred, emulsification is not absolutely essential to the operation of the system.

Subsequent to emulsification, the material is analyzed using the analyzer(s) 16. Generally speaking, it has been found that improved analyses are obtained with devices which generate energy which is transmitted through a cross section of the material to be analyzed, with analysis data being received and manipulated to obtain useful information. For example, particularly good results have been obtained with near infrared (NIR) analyzers such as those commercialized by ESE, Inc. of Marshfield, Wis., for determining moisture, fat, salts and protein contents, and pH and viscosity values on an instantaneous, real-time basis. Also, guided microwave analyzers such as those produced by Thermoelectron Corporation can be used to measure moisture and fat contents. These types of analyzers have a transmitter positioned adjacent the stream of material and an opposed receiver, so that the energy signal is transmitted through the product. This is to be contrasted with other types of analyzers which are based on reflectance of a signal off a surface of the product; these types of analyzers do not generate data representative of the entire cross-section of the material. Other types of analyzers which may be used in this context include X-ray and ultrasound analyzers.

The data generated by the analyzer(s) 16 is directed to a system control microprocessor 28 which is operatively coupled via leads 30, 32, 34, and 36 to the analyzer(s) 16, the additive input 26 and the incoming stream 10, recycle valve 38 for control purposes, and to extrusion additive control line 40. Those skilled in the art will appreciate that these leads are coupled to appropriate pumps or valves in order to control the operation of the overall system.

Depending upon the data received from the analyzer(s) 16, a so-called “product signature” is generated in microprocessor 28. This signature is used in the control of the overall system so as to ensure that the final product stream 18 is of desired characteristics. Such control may include recirculation of a portion of the output from analyzer(s) 16 through line 42 back to blender/pump 12. Also, it may involve addition of protein, water, fat/tallow or other minor ingredients through input 30. Hence, the system can generate the final product stream 18 for direct extrusion in system 20. To this end, a surge tank 44 may be provided in the final product line to control flow of the finished product to system 20; alternately, the product 18 may be sent to temporary storage facility 46 before use thereof. It will be understood that the key to production of the consistent output final product 18 is the accurate analysis of the emulsified product via the analyzer(s) 16.

In actual operation using the system of FIG. 1, the incoming waste stream is of extremely variable ingredient makeup and have differing physical properties such as size, viscosity and pH. The product may initially be reduced at 22 or fed directly to blender/pump 12. The latter is filled to a predetermined level of either volume or weight, and is designed to homogeneously mix the incoming product. Once a fill level is reached and the desired degree of mix is obtained, a material is pumped out of the blender through the emulsifier 14 and then to the process analyzer(s) 16. The information accumulated from the analyzer 16 is used to determine the batch product signature, containing all information that is critical to the final product specification. If recirculation is required, a portion of the analyzed material is directed through line 42 back to blender/pump 12. Also, during the steps of the FIG. 1 process, the temperature of the material is monitored so that if the temperature is too low or too high, steam and/or CO2 and/or cold water may be injected at blender/pump 12. Also, fat, protein, starch and water levels may be adjusted at the blender/pump 12 through the input lines 30. If contaminates are detected by the analyzer 16, such can be diverted using a diversion valve (not shown). Once the batch is homogeneous and the desired ingredient makeup and temperature have been achieved, the product 18 is directed for downstream extrusion as explained. However, the system allows a further control opportunity by way of additive line 40, i.e.,appropriate ingredient make-up may be made at the extrusion system, if desired. It will also be understood that the use of adjusted waste stream 18 is usually not the primary feed to extrusion system 20; rather, an incoming primary stream 48 of extrudable material is fed to system 20 in the usual way, with the stream 18 and additives 40 be secondary thereto.

The system of FIG. 1 is in the form of a batch process. FIG. 2 illustrates a similar system which is in-line and continuous. In the FIG. 2 system many of the same components are employed for the same purpose as compared with FIG. 1, and therefore like reference numerals are used where appropriate and no additional discussion of these components is provided. Thus, in FIG. 2, the in-line system is identical with FIG. 1, except that no recycle from the analyzer(s) to pump/blender 12 is present, and accordingly the hookup of microprocessor 28 is different. Also, because of the in-line nature of the FIG. 2 system, surge control is normally not required.

The operation of the in-line system is closely analogous to that of the FIG. 1 batch system, differing only in the fact that no recycle is present. Again, the use of the analyzer(s) 16 coupled with the microprocessor 28 is a key step in the reliable production of consistent waste stream products at 18 for subsequent extrusion.

Concurrently filed applications for U.S. Letters Patent entitled Animal Protein Products Usable as Ingredients in Extruded Products (S/N______, filed ______) and Method and Apparatus for Providing Instantaneous, Real-time Data for Extrusion Process Control (S/N ______, filed ______) are incorporated by reference herein.

1. A method of managing waste and/or animal protein-containing streams in extrusion processing, comprising the steps of:
providing an incoming waste stream including respective quantities of fat, protein, and moisture;
blending said stream in a blender with the optional addition of additives to said blender;
using an analyzer to analyze said blended material to determine at least the moisture content thereof;
creating an output stream downstream of said analyzer;
adjusting the characteristics of said output stream in response to said analysis by addition of further quantities of said waste stream and/or fat, protein, starch and water; and
directing said adjusted output stream to an extruder for extrusion processing thereof.

2. The method of claim 1, said adjusting step comprising the step of recirculating at least a portion of said analyzed stream and addition of said portion to said blender.

3. The method of claim 2, said adjusting step comprising the step of adding ingredients selected from the group consisting of fat, protein, starch and/or water to said blender.

4. The method of claim 2, including the step of storing data from said analysis in a microprocessor operably coupled with said blender and said analyzer, and using said microprocessor to control the operation of said blender.

5. The method of claim 1, including the step of reducing the particle size of said stream prior to entrance thereof into said blender.

6. The method of claim 1, including the step of adding steam and/or carbon dioxide to said blender.

7. The method of claim 1, said method being a batch method.

8. The method of claim 1, said method being a continuous method.

9. The method of claim 1, said analysis step including the steps of analyzing the stream to determine at least one characteristic of the stream selected from the group consisting of the protein content, fat content, starch content, pH, viscosity, solids content and presence of contaminants.

10. The method of claim 9, including the step of analyzing the stream to determine a plurality of said characteristics.

11. The method of claim 1, said analyzer selected from the group consisting of microwave, infrared, X-ray and ultrasound analyzers.

12. The method of claim 11, including the step of using a plurality of said analyzers to analyze said emulsified material.

13. The method of claim 1, including the step of introducing other additives into said extruder for extrusion thereof along with said adjusted output stream.

14. The method of claim 13, said other additives selected from the group of fat, tallow, water and steam.

15. The method of claim 1, including the step of emulsifying said blended stream prior to said analysis step.

16. The method of claim 15, said emulsification being carried out so that the stream comprises particles having a maximum dimension of up to about 7mm.
